(19) United States
(12) Patent Application Publication
(10) Pub. No.: US 2005/0081150 A1
(43) Pub. Date: Apr. 14, 2005

(54) Method and apparatus for text messaging

(76) Inventor: Paul Rowland Beardow, Surrey (GB)

Correspondence Address: ROBERT W. J. USHER;PATENT AGENT, 1133 BROADWAY, #1515, NEW YORK, NY, 10010, US

(21) Appl. No.: 10/494,254

(22) PCT Filed: Nov. 1, 2002
(86) PCT No.: PCT/GB02/04995

(30) Foreign Application Priority Data
Nov. 2, 2001 (GB) 0126464.7

(51) Int. Cl. G06F 15/00; G06F 17/24; G06F 17/21; G06F 17/00

(52) U.S. Cl. 715/531

(57) ABSTRACT

Apparatus (10) for generating text messages comprises means for selecting, from a library, a sequence of text images (22) to form a message, each text image having associated therewith a sequence of characters, means to concatenate the characters to form a text message, and means (12, 14, 16, 18) to send the text message to a selected recipient (20). Apparatus for receiving and viewing text messages comprises means (10) to receive a string of characters, successively comparing the characters in the string with each of a stored array of groups of characters to seek any match therebetween, where each group of characters has, associated therewith, a respective image (22), and means successively to display the string of characters and the associated image together.

The present invention relates to mobile telephones, and particularly relates to mobile telephones with the ability to send and receive text messages. Most particularly, the invention relates to mobile telephones which have, in addition, the ability to display images on a screen.

“Texting” is the sending of an alphanumeric characters string from one mobile telephone to another. A text message is composed by selecting alphanumeric characters on the display screen of the mobile telephone originating the text message using the dialpad keys. A dialpad key may have to be pushed several times before the desired character is displayed. The character is confirmed and the display moves on to the next character position. Once the entire text message has been assembled, it is sent, via the radio and terrestrial telephone network, to the telephone number of the receiving mobile telephone, where it is automatically received and stored to be read, under the control of the user, at a later time. The composition of a text message, using plural strokes on individual keys, is time consuming, laborious, and prone to error. The present invention seeks to provide a more efficient, more accurate, easier and more entertaining means for composing a text message.

Not everyone is literate. The benefits of text messaging are unavailable to those who cannot read or write. The present invention seeks to provide a method and apparatus capable of use and interpretation, without a need for literacy, in a text messaging environment.

Not everyone speaks the same language, or knows more than one language. Text messages, created in a first language, may be totally unintelligible to a speaker of a second language who has no knowledge of the first language. The present invention seeks to provide a method and apparatus for text messaging that provides intelligibility across language barriers.

According to a first aspect, the present invention consists in a method for receiving and viewing text messages, including the steps of: receiving a string of characters; successively comparing the characters in the string of characters with each of a stored array of groups of characters to seek any match there-between, where each group of characters has, associated therewith, a respective image; successively displaying the string of characters; and, for any portion of the string of characters for which a match has been found, displaying the associated image together with that portion of the string of characters.

According to a second aspect, the present invention consists in an apparatus for receiving and viewing text messages, said apparatus comprising: means to receive a string of characters; means successively to compare the characters in the string of characters with each of a stored array of groups of characters to seek any match there-between, where each group of characters has, associated therewith, a respective image; means successively to display the string of characters; and means to display, for any portion of the string of characters for which a match has been found, the associated image together with that portion of the string of characters.

The invention further provides that a group of characters can also have, associated therewith, one or more alternative portions of the string of characters, a selectable one of said one or more alternative portions being displayable with said associated image.

The invention further provides that the selected alternative portion can be displayed instead of the portion of the string of characters for which a match was found.

The invention further provides that the portion of the string of characters can be displayed in a text box within the associated image.

According to a third aspect, the present invention consists in a method for generating text messages, including the steps of: selecting, from among a library of text images, a sequence of text images to form a message, each text image having associated therewith a sequence of characters; concatenating the sequence of characters to form a text message; and sending the text message to a selected recipient.

According to a fourth aspect, the present invention consists in an apparatus for generating text messages, said apparatus comprising: means for selecting, from among a library of text images, a sequence of text images to form a message, each text image having associated therewith a sequence of characters; means to concatenate the sequence of characters to form a text message; and means to send the text message to a selected recipient.

The present invention further provides that at least some of the text images are representations, pictograms or ideograms of the content of associated sequence of characters.

The present invention further provides that a sequence of characters can independently be entered, that a textless image can be selected from among a plurality of textless images, and that the independently entered sequence of characters can be associated with the selected textless image and stored in said library as a text image.

The present invention further provides that the recipient of a text message can be selected by selecting an image, representative of the desired recipient, from among a plurality of images of prospective recipients.

The present invention further provides that an independently entered recipient identification can be associated with a selectable one from among a plurality of images, each potentially representative of a recipient, and stored among said plurality of images of prospective recipients.

The present invention further provides that an image of any kind can be a caricature, a cartoon, a drawing or a photograph, and that the image can be obtained from a server, a photographic source, by composition of elements from a store of elements, or from a pre-decided store.

The present invention further provides that the apparatus can be a mobile telephone, a personal digital assistant or a computer.

The present invention is further explained, by way of example, by the following description, read in conjunction with the appended drawings, in which:

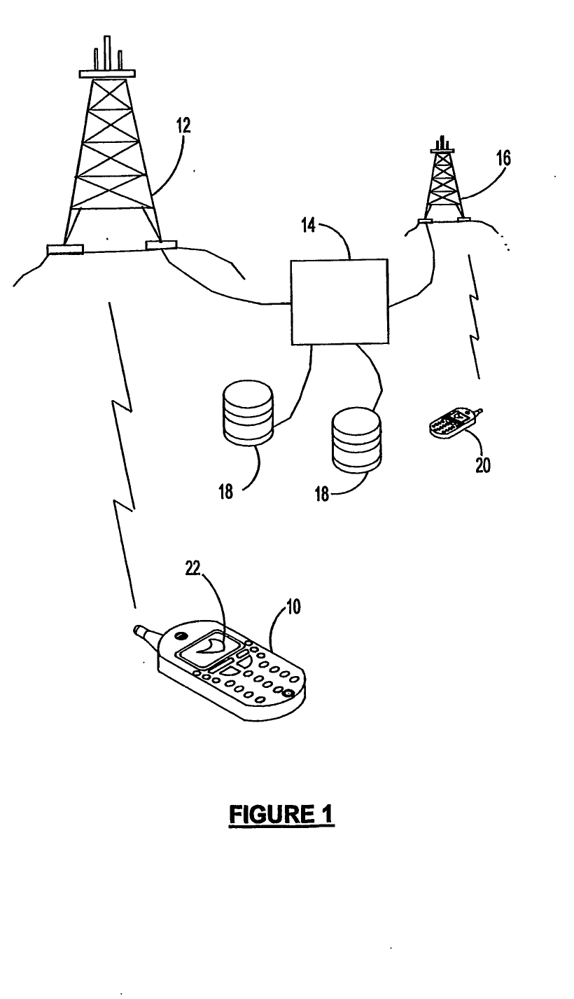

FIG. 1 is a schematic diagram of the environment in which the preferred embodiment of the invention is practised.

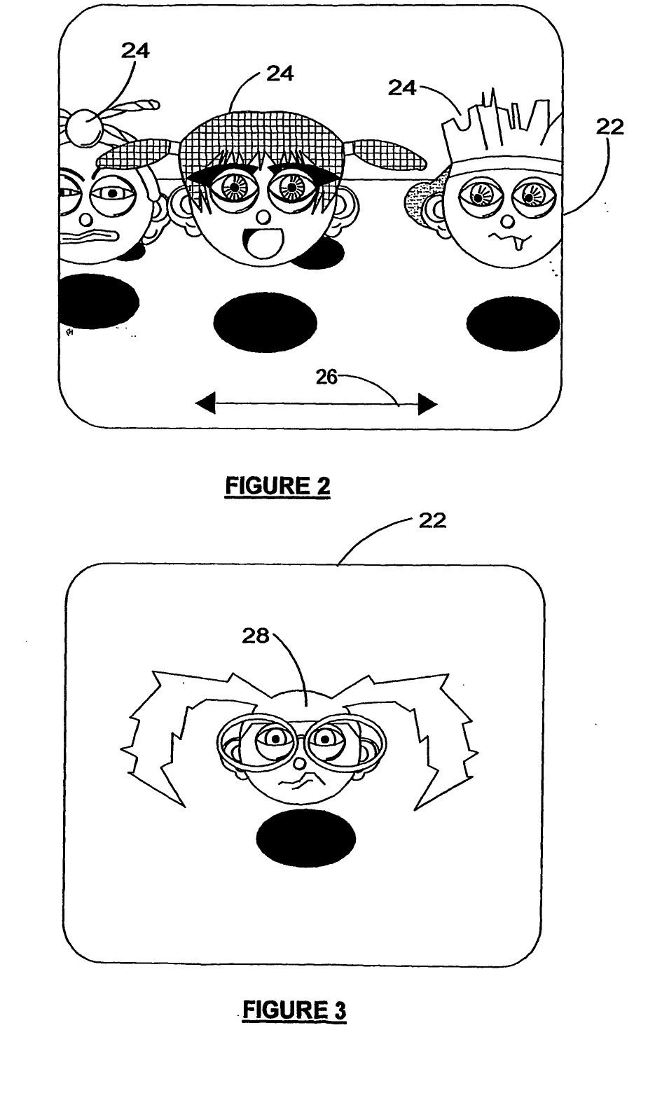

FIG. 2 shows an exemplary screen, on the mobile telephone of FIG. 1, used to select the recipient of a text message.

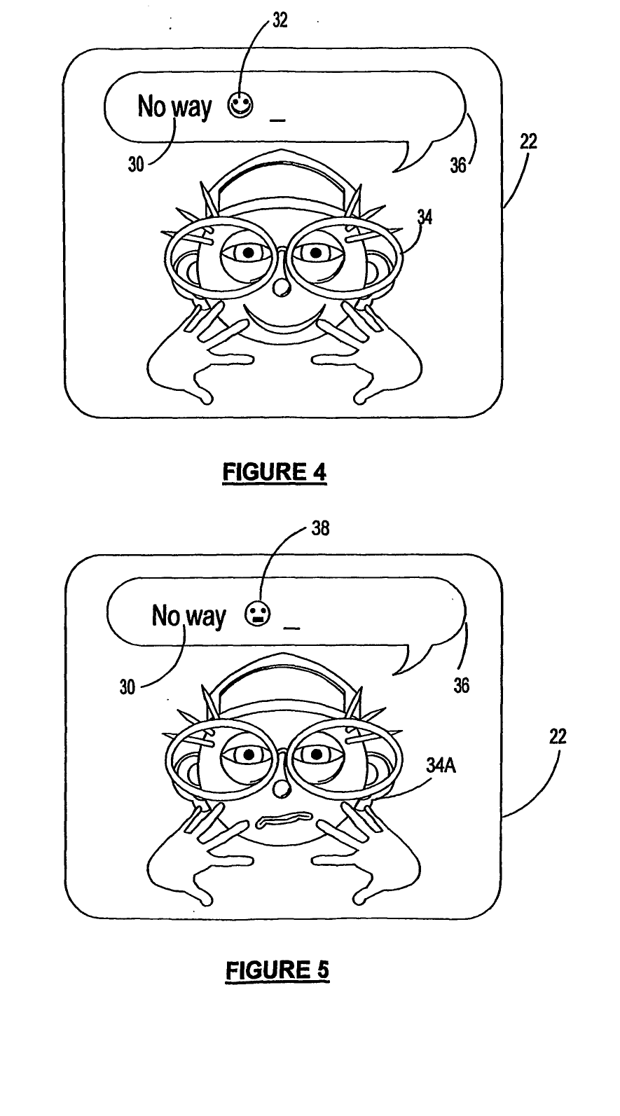

FIG. 3 shows an exemplary screen, on a text message originating mobile telephone where a text message recipient has been selected.

FIG. 4, 5, 6 and 7 show different emotional icons (Emoticons) which can be appended to a text message.

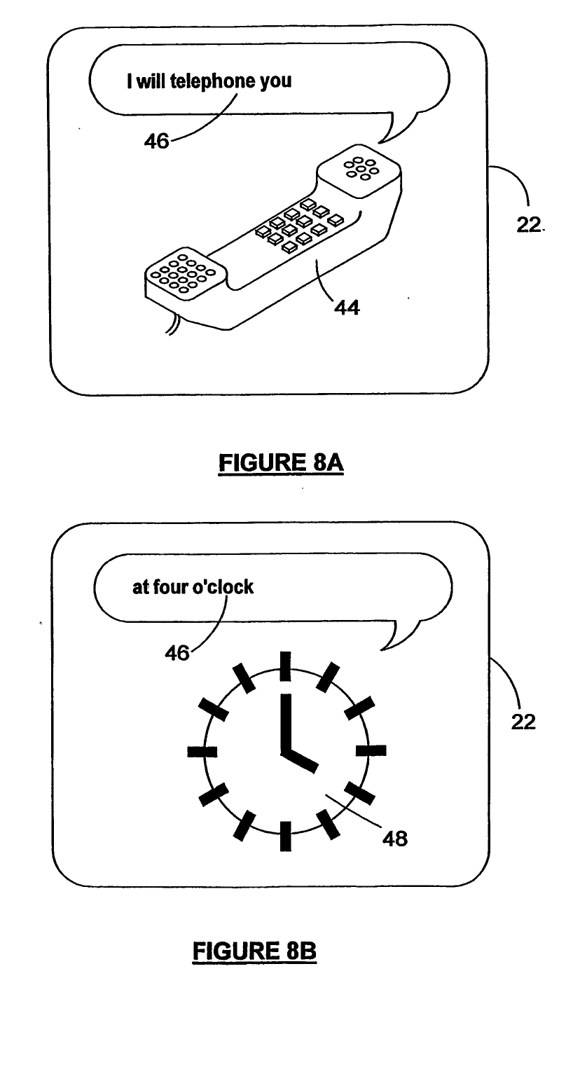

FIGS. 8A and 8B show how a simple text and pictographic message can be assembled using a “standard set” of message icons.

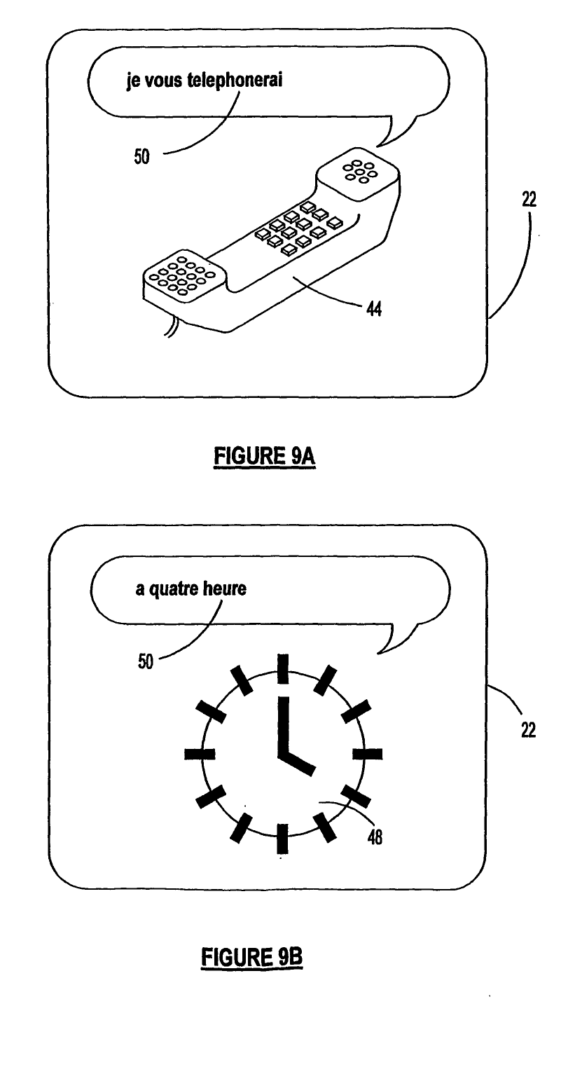

FIGS. 9A and 9B show how a simple message of FIGS. 8A and 8B can, on receipt, be changed to another language.

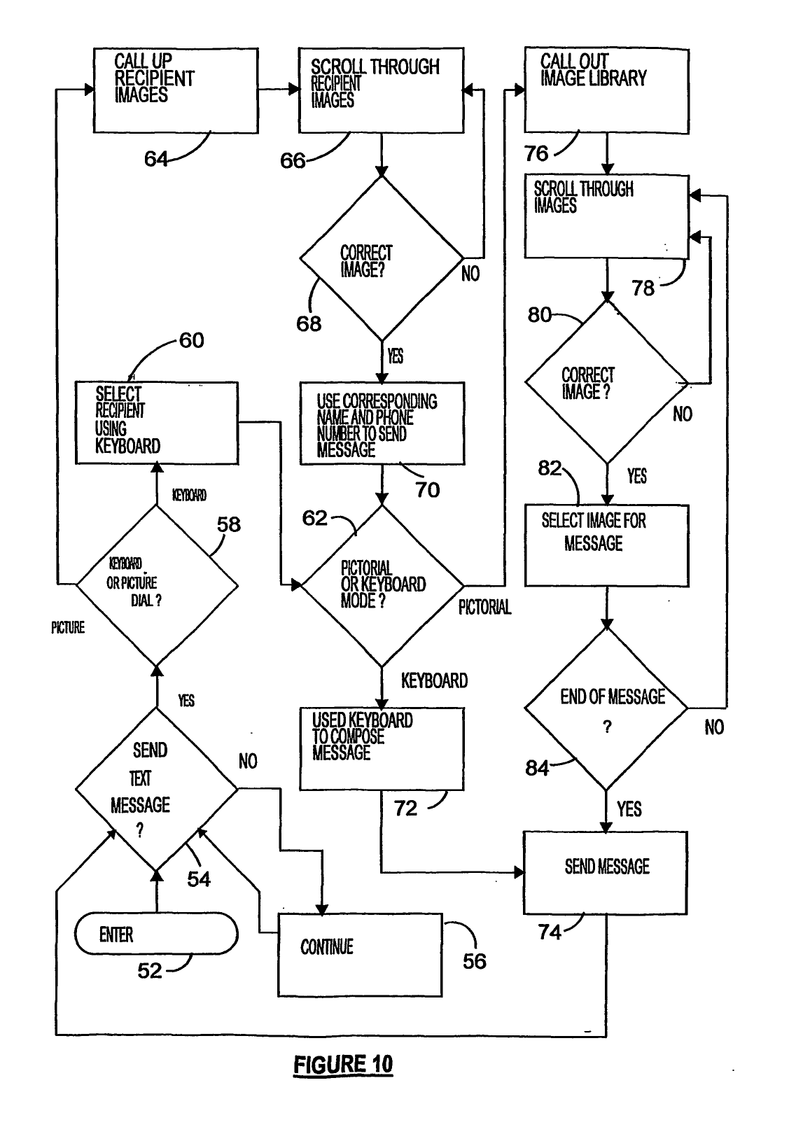

FIG. 10 is a flowchart showing how a mobile telephone can construct and send a text message according to the present invention.

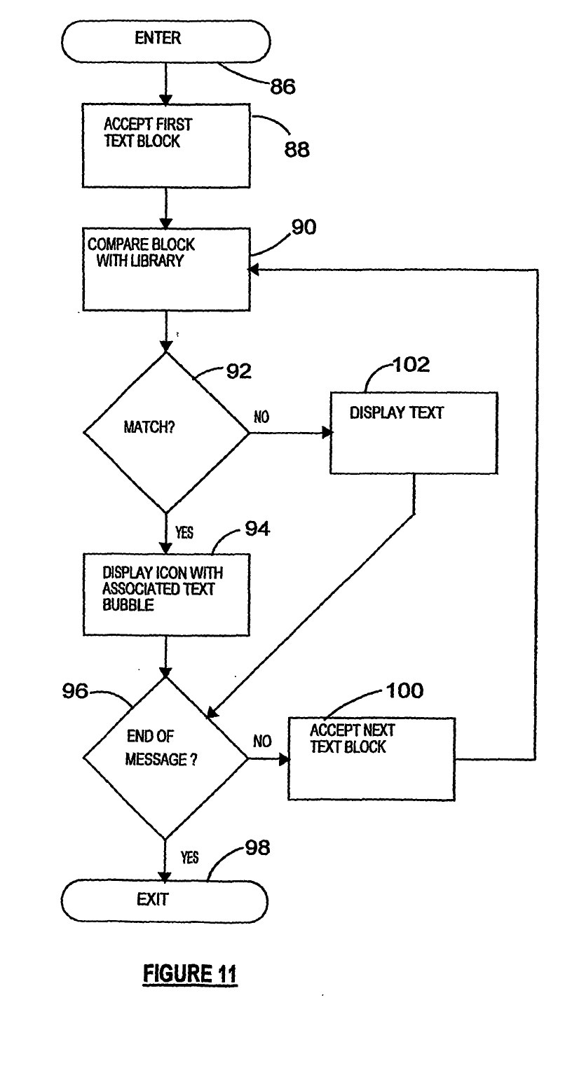

FIG. 11 is a flowchart showing the manner in which a text message, according to the present invention, can be received even by a mobile telephone which is not equipped to display images.

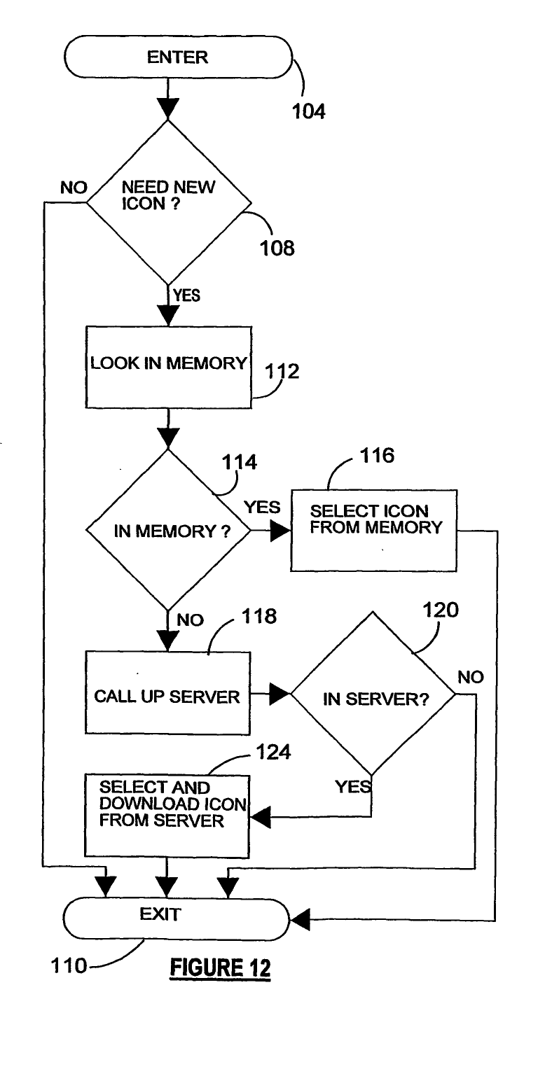

FIG. 12 is a flowchart showing how a mobile telephone can acquire icons for use in creating or receiving text messages.

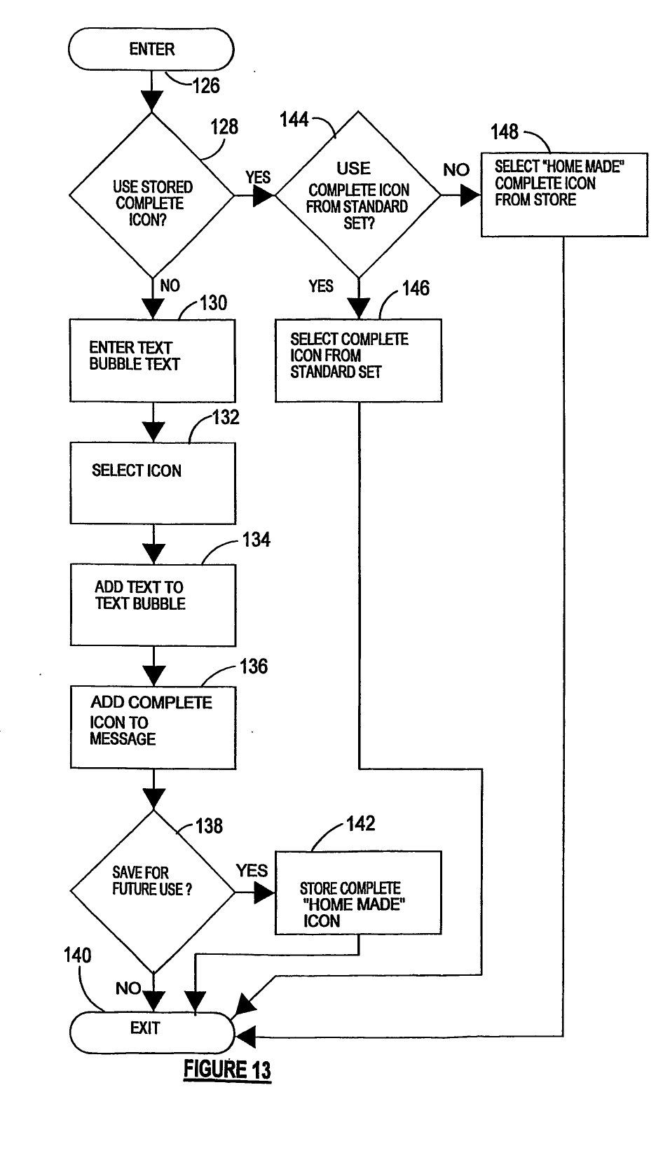

FIG. 13 is a flowchart showing the fine detail of how a text message can be assembled.

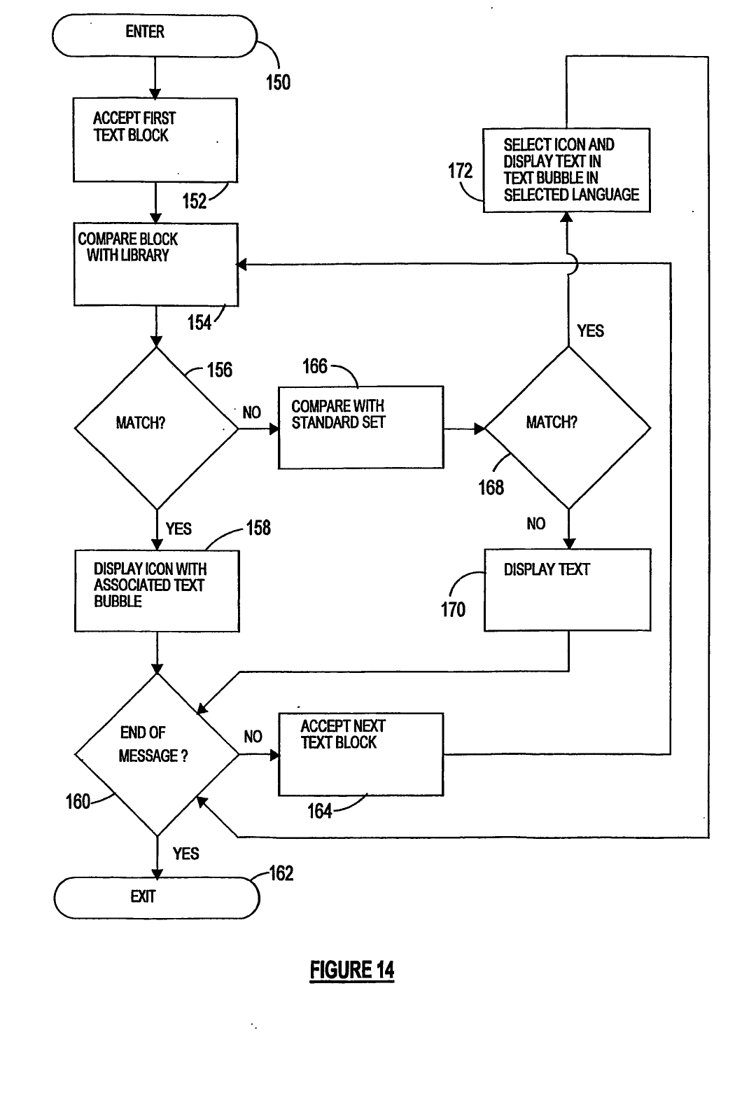

FIG. 14 is a flowchart, elaborating over the flowchart of FIG. 11, showing how a text message can be received in a manner permitting the language change illustrated between FIGS. 8A and 8B and 9A and 9B.

Attention is drawn to FIG. 1, showing the general environment in which the preferred embodiment of the invention is practised.

A mobile telephone 10 is in radio communication with a mobile telephone network base station 12 which is, in turn, connected via the terrestrial telephone network 14 to other base stations 16 and one or more servers 18. The terrestrial telephone network 14 can comprise land lines, high band width cables, and microwave and satellite links. The terrestrial telephone network 14 allows connection to other mobile telephones 20, fixed telephones and fixed computer terminals. A mobile telephone 10 can access a server 18 for data, information and other resources. The base stations 12 can be on any style or generation of mobile telephone system, provided it has the ability to transfer text messages. The mobile telephone 10, which in this example is taken to be a mobile telephone 10 capable of sending text messages according to the present invention, comprises a screen 22 capable of displaying images.

The mobile telephone 10 is the preferred method of transmission and reception in the chosen embodiment of the present invention. It is to be appreciated that the present invention encompasses any means for sending and receiving text messages and is not limited to mobile telephones 10, 20 or a mobile telephone network 12, 14, 16. The present invention equally allows personal digital assistants (PDA), computers and computer terminals to communicate through any other system including, for example, the internet, by satellite, or by direct wire or cable connection.

Attention is drawn to FIG. 2, showing an exemplary image on the screen 22 which can be displayed when commencing a text message.

The first act, when creating a text message, is usually to select the recipient for the text message. It is to be understood that the recipient can also be selected after the text message has been assembled. In this example, the recipient is identified before assembling the text message.

Using control buttons on the mobile telephone 10, a “select recipient” option is chosen which causes images of proposed recipients 24 to be displayed on the screen 22 and to be moved in a scrolling fashion as indicated by arrow 26 until the image of the required recipient is at centre screen or some other selection point.

When the image of the actual recipient 28 is at centre screen, the user of the mobile telephone 10 chooses an “accept recipient” option, which leaves the single image of the actual recipient 28, on the screen 22, as shown in FIG. 3.

The proposed recipients 24 and the actual recipients 28, shown in FIGS. 2 and 3, are cartoon caricatures which can be downloaded from a server 18, created by the user of the mobile telephone 10 themselves, or can be derived from a store of possible images maintained in accessible memory in the mobile telephone 10. Equally, instead of cartoon faces, actual photographic images of proposed recipients 24 and actual recipients 28 can be used. Other images and symbols can also be used. For example, images of different animals or creatures such as a bear, a tortoise and so on, can be used.

Attention is drawn to FIGS. 4, 5, 6 and 7, showing different ways in which a text message can be assembled according to the present invention.

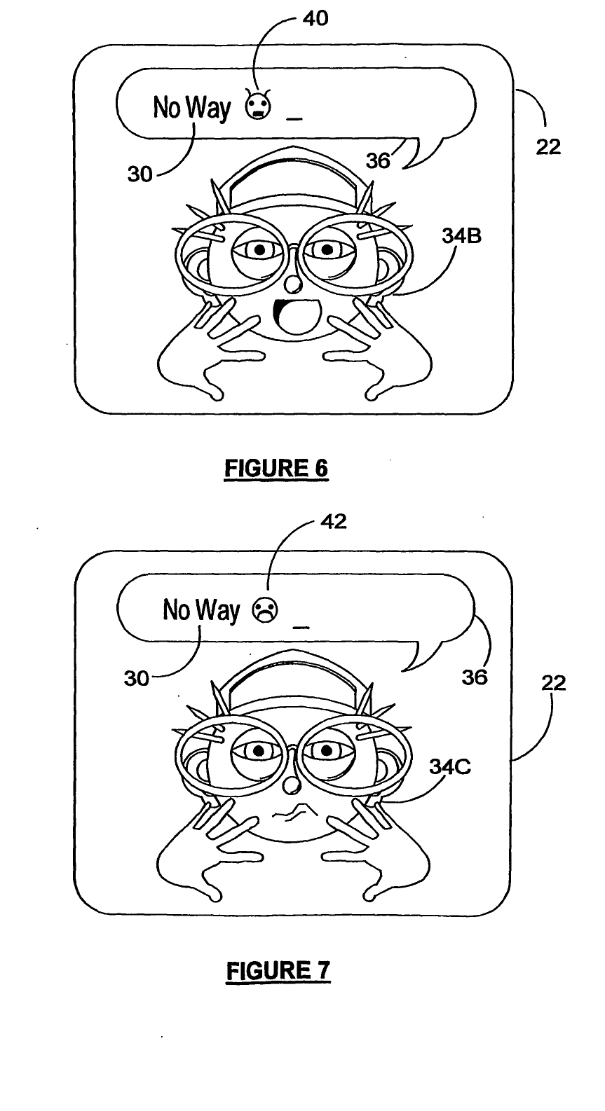

A text message 30 is assembled using the keys on the mobile telephone 10 in the normal way. An emoticon 32 is appended, by key strokes well known in text messaging, to the text message 30. This has the effect of calling up a related image 34 which, graphically, expresses the feeling of the emoticon 32. The text message 30 and the emoticon 32 are displayed within a text bubble 36. A different related image 34 is provided for each emoticon 32. FIG. 4 shows the related image 34 for a happy emoticon 32. FIG. 5 shows the related image 34A for an angry emoticon 38. FIG. 6 shows the related image 34B for an excited emoticon 40. FIG. 7 shows the related image 34C for an unhappy emoticon 42. It is to be appreciated that different forms of related image 34 can be used, and that the text message 30 and the emoticons 32, 38, 40, 42 can be displayed elsewhere on the screen other than in a text bubble 36.

Attention is next drawn to FIGS. 8A and 8B which show, in sequence, a simply constructed message from a standard set of selectable icons. Each member of the standard set comes with its own image and its own message. For example, in FIG. 8A a telephone call icon 44 comes with a standard message 46 indicating that the sender will place a telephone call. The sender simply scrolls through a selection of standard set icons and selects, in order, those which make up the desired message. In FIG. 8B a standard set time icon 48 has been selected to indicate, with its standard message 46, the time “at four o'clock”. The two consecutive images in FIGS. 8A and 8B therefore convey the message “I will telephone you at four o'clock”. Because of the pictographic or ideographic quality of the images, a person who cannot read will be able to understand, by looking at the sequence of standard icons 44, 48 what is the message that is conveyed. The standard message characters 46 are sent as if they had been keyed on the mobile telephone 10 by the user. Thus, all that is transmitted is the standard message 46 selected in each instance.

Attention is now drawn to FIGS. 9A and 9B showing how language translation of the elements transmitted in FIGS. 8A and 8B can be achieved on reception.

On receipt, if the receiving mobile telephone 10 is enabled with full graphic and standard set capacity, the same standard set icons 44, 48 appear. However, the standard messages 46 are of a limited number and of a fixed form. The receiving mobile telephone 10 can either display the standard messages 46 as they are received, or can consult a library of standard messages 46 to find a match. Because of the limited number of standard messages 46, it is a very fast and easy task to achieve. Once a match has been found, a selected standard message 48 can be displayed in place of the actual standard message 46 that was received. In the example given in FIGS. 9A and 9B the standard message 46 has been translated into a corresponding selected message 48 in the French language. Thus, a sender of a text message in English is able to obtain automatic translation into another language. This would still happen even if the receiving mobile telephone 10 were incapable of showing the standard set icons 44, 48. The recognition of the incoming standard message 46 causes the appropriate standard set icons 44, 48 to be displayed.

This feature is useful, not only for language translation, but also for passing messages which would not be understandable to others, For example “cup of tea” might be displayed as “glass of beer in the bar” or “cannot see you” might be displayed as “meet you at the usual place”. All that is required is that the recipient has, in their mobile telephone, a suitable alternative message agreed with the sender. As will later be seen, it is possible, within the invention, to provide such alternative messages.

Attention is drawn to FIG. 10, which is a flowchart of the manner in which a mobile telephone 10 can construct a text message according to the present invention.

From entry 52 a first test 54 checks to see if the user has elected to send a text message. If not, a first operation 56 continues the normal function of the mobile telephone 10 until there is a change.

If the first test 54 has detected that the user of the mobile telephone 10 wishes to send a text message, a second test 58 checks to see if the user wishes to dial the recipient via the keyboard on the mobile telephone 10, or to use the image process otherwise described in FIG. 2 and FIG. 3.

If the user of the mobile telephone 10 wishes to dial in the normal manner, a second operation 60 allows the keyboard on the mobile telephone 10 to be used to select the recipient of the text message in the normal manner. The second operation 60 then passes control to a third test 62 which checks to see whether or not the text message is to be assembled in pictorial or keyboard mode. The third test 62 will be described in more detail hereafter.

If, in the second test 58, the user elects to select the recipient of the text message using the pictorial mode, a third operation 64 calls out, from the memory of the mobile telephone 10, the images of proposed recipients 24 for display on the screen 22. In a fourth operation 66 the user scrolls through the displayed array of proposed recipients 24 until a fourth test 68 detects that the correct image has been selected (by way of the user's indication) when control passes to a fifth operation 70 where the name and phone number of the actual recipient 28 are automatically selected as the destination of the text message. Control then passes to the third test 62, earlier briefly described.

The third test 62 checks the user's desire either to use a pictorial mode for creating a text message or to use the ordinary keyboard mode, known in the prior art.

If the user elects to use the keyboard manner of creating a text message, a sixth operation 72 compiles the text message using the multiple stroke of dial pad keys according to the known prior art. Thereafter a seventh operation 74 sends the message in the normal way and returns control to the first test 54.

If, at the third test 62, the user elects to compose the text message using the pictorial manner, an eighth operation 76 calls out, from the memory of the mobile telephone 10, a selection of images which can be attached to text messages. As will later be described, a standard set image may be called out, in which case its standard message 46 is fixed for the particular image, or additional images (as shown in FIGS. 4, 5, 6 and 7) may be called out to have text added thereto.

In a ninth operation 78 the user of the mobile telephone 10 scrolls through the message images until a fifth test 80 detects that the user has found an appropriate image. The tenth operation 82 then selects that image for the message. As will later be described, text can be embedded in that message image in various ways.

A sixth test 84 checks to see if the entire message, according to the user, has been assembled. If it has not, control passes back to the ninth operation 78, where a new image is selected. If it is the end of the message, control passes to the seventh operation 74 where the message is assembled and sent in the normal manner.

Attention is drawn to FIG. 11, a flow chart showing how a mobile telephone 10 can receive a text message according to the present invention.

From entry 86, an eleventh operation 88 looks at the first block of text which has been received. A twelfth operation compares that block with the blocks stored in a library in the memory of the mobile telephone 10. If a seventh test 92 locates an icon in the library, which corresponds to one or more elements in the block of text, the icon is displayed in a thirteenth operation 94. If an eighth test 96 detects that the entire message has been viewed, the process terminates in exit 98. If the entire message has not been viewed, a fourteenth operation 100 brings in the next block of text and returns control to the twelfth operation 90. In the thirteen operation 94 the icon is displayed, together with the text which evoked the icon, in the text bubble.

If the seventh test 92 did not find a match in the twelfth operation 90 where the incoming text is compared with a library of matchable text, a fifteenth operation 102 displays simply the text as it was received.

Although, in association with FIG. 11, the text has been shown to be matched in blocks to text templates in the library held in the memory of the mobile telephone in the twelfth operation 90, it is to be appreciated that matching can be accomplished character by character if so required. This is especially important where emoticons are concerned.

In the scheme shown in FIG. 11, a received message, when viewed, will have any associated icons scrolled across the screen as the message is read. The scrolling can be automatic or controlled by the user. As a particular text block or character is called onto the screen 22, its associated icon is displayed and moves across the screen 22. If no icon can be associated with a piece of text, the simple text is displayed. As an icon evoking text block or character leaves the screen 22, its associated icon disappears.

By this means, a mobile telephone 10, equipped to display pictorial mode according to the present invention, can equally display plain text derived from a mobile telephone 10 of simpler design. Equally, because, according to the present invention, only the normal text characters are sent in a text message, a message, originating from a mobile telephone 10 according to the present invention, can be read by a normal mobile telephone 10 of simpler design.

Attention is drawn to FIG. 12, showing the manner in which a mobile telephone 10 can acquire a new icon for use in any of the activities described in conjunction with the previous figures. For example, an icon might be needed to provide a visual address for a new recipient. Equally, a new icon may be required to accept a text bubble, or a new icon for a fixed set may also be required.

From entry 104, a ninth test 108 checks to see if the user requires a new icon for whatever task he is presently undertaking. If no new icon is required, control passes to exit 110 where the user carries on with whatever task he happens to be performing.

If the ninth test 108 detects that a new icon is required, control is first passed to a sixteenth operation 112 which looks into the memory of the mobile telephone 10 and extracts any icons or visual images or photographs. The user can examine what is present, and select a suitable icon for his purpose. If a tenth test 114 detects that the user has found a suitable icon, a seventeenth operation 116 has the user select the icon from the memory of the mobile telephone 10 and then proceed, with that icon, to exit 110.

If the tenth test 114 detects that the user has been unable to find an acceptable icon or image in the memory of the mobile telephone 10, an eighteenth operation 118 has the mobile telephone 10 call up the server 18 (otherwise shown in FIG. 1) via the base station 12 and the terrestrial telephone network 14 to obtain a suitable icon or image. The server 18 provides sight of what it has available and an eleventh test 120 monitors to see if the user can find an acceptable icon image or photograph. If the user cannot find, in the server 18, a suitable icon image or photograph, then the user has been totally unable to locate an acceptable image source, and leaves the routine via exit 110 without having found what he requires. Procedure will then be strictly on an alphanumeric basis.

If, however, the eleventh test 120 detects that the user has found a satisfactory icon, image or photograph in the server 18, control passes to a nineteenth operation 124 where the acceptable image is selected and downloaded to the mobile telephone 10 for use thereafter, and control then passes to exit 110 for the user to continue with whichever task required the new icon image or photograph.

Attention is drawn to FIG. 13 showing a flow chart detailing how a text message can be assembled. The flow chart of FIG. 13 corresponds, roughly, to the activities described in the eighth operation 76, the ninth operation 78, the fifth test 80 and the tenth operation 82, all shown in FIG. 10.

From entry 126, a twelfth test 128 checks to see if the compiler of the text message wishes to use a “complete” stored icon. If the compiler does not wish so to do, a twentieth operation 130 has the compiler enter text to be stored in an icon text bubble. Thereafter, a twenty-first operation 132 has the compiler scroll through available icons to select an icon to carry the text entered in the twentieth operation 130. A twenty-second operation 134 then has the text, entered in the twentieth operation 130, added to the text bubble 36 of the selected icon. At this stage it is to be appreciated that the selected icon will not be transmitted. Only the text, in its text bubble 36, will be transmitted. However, the selected icon forms a convenient vehicle for storing a pre-recorded message. After the twenty-third operation 136 has added the completed icon to the message, a thirteenth test 138 checks to see if the compiler wishes to save the block message entered in the thirtieth operation 130. If the compiler does not wish so to do, the selection of a component for the text message is complete and operation proceeds to exit 140. If, however, the compiler does wish to save the text, entered in the twentieth operation 130, a twenty-fourth operation 142 stores the complete “home-made” icon in the mobile telephone 10 such that it can be recalled complete with fixed message. Thereafter, control passes to exit 140.

In the way described immediately above, text of a fixed nature can be stored within the mobile telephone 10 to be recalled as a block. Messages may be recalled by the icon, with its text bubble, being selected on the basis of an image from among a plurality of home-made complete icons which have been similarly stored. The recipient of the home-made fixed message need not display any icon on receipt of the fixed home-made message unless the recipient has pre-programmed his mobile telephone 10 to display an icon.

The twelfth test 128 may detect that the compiler of a text message does indeed desire to use a stored complete icon for his message. A fourteenth test 144 checks to see if the compiler desires to use a complete icon from a standard set, such as was described with reference to FIGS. 8A, 8B, 9A and 9B. If the compiler so desires, a twenty-fifth operation 146 allows the compiler to scroll through complete icons from the standard set and to select the icon to be added into the message. Thereafter control passes to exit 140.

If the fourteenth test 144 does not detect that the compiler wishes to use a complete icon from a standard set, control passes to a twenty-sixth operation 148 where the compiler of the text message can scroll through and select from among one or more home-made complete icons as earlier discussed with reference to the twenty-fourth operation 142. When a home-made complete icon has been selected, control once again passes to exit 140.

Once again, it should be emphasised that when a text message is sent, only the alphanumeric characters and keystrokes are sent. Where an icon appears in a message on a receiving mobile telephone 10, it is because the receiving mobile telephone 10 has called the icon from its own store of images to be appended to an appropriately detected portion of a text message.

Attention is now drawn to FIG. 14. FIG. 14 shows how a mobile telephone 10 can receive a text message, according to the present invention and, in particular, can achieve language translation as illustrated between FIGS. 8A, 8B, 9A and 9B.

When receiving a text message, a mobile telephone 10, configured according to the present invention, commences with entry 150 and thereafter with a twenty-seventh operation 152 where the receiving mobile telephone 10 begins to examine the text message which it has previously received and stored. A first element, which can be a single character or a block of text, is accepted. Then a twenty-eighth operation 154 compares the text received in the twenty-seventh operation 152 with the contents of a library of text elements, blocks and strings. If an element, received in the twenty-seventh operation 152, matches a stored string in the library, an appropriate icon, associated with that string in the library, is activated. If a fifteenth test 156 discovers that there is a match in the library of icons, a twenty-ninth operation 158 causes the matched icon to be displayed with the associated test in its text bubble 36. If a sixteenth test 160 detects that it is the end of the whole message which has been received by the receiving mobile telephone 10, the reading process is terminated via exit 162. If the sixteenth test 160 does not detect that it is the end of the whole message, a thirtieth operation 164 accepts the next block of text which the receiving mobile telephone 10 has previously received, and returns control to the twenty-eighth operation 154 to look for more matches with icons.

If the fifteenth test 156 does not detect a match between the incoming text and the icons stored in the library, a thirty-first operation 166 compares the incoming text with the text set available with the individual icons in each element of a standard set of icons, as illustrated in FIGS. 8A, 8B, 9A and 9B. If a seventeenth test 168 can find no match with the incoming text and the text set associated with the standard set, a thirty-second operation 170 simply displays the text, as it is received, without any icons, and returns control to the sixteenth test 160. If, however, the seventeenth test 168 does detect a match between the text character sets in the standard set of the thirty-first operation 166 and the incoming text characters, control is passed to a thirty-third operation 172 which selects one of the sets of associated text to be displayed in the appropriate icon. If, for example, the incoming text block was in English, the user of the receiving mobile telephone 10 can elect that the thirty-third operation 172 displays the associated French version of the text in the text bubble of the appropriate icon. Thus, receiving text in one language, finding a match with that language version in a set of versions in different languages, and displaying the text in the selected different language enables automatic translation of simple messages from one language to another.

The action of the thirty-third operation 172 in displaying the other language version (which, equally, could be the same language) being done, control passes to the sixteenth test 160.

To summarise the present invention, a mobile telephone 10, enabled according to the present invention, can compose and send text messages using graphics. The composed text message is sent as a simple stream of alphanumeric characters which can also be decoded by a mobile telephone 10, which is not enabled according to the present invention. When received by a mobile telephone 10, configured according to the present invention, graphic material such as icons or photographs may be called from a memory to be displayed with the text message as a match is found between the text message key relating to that icon or image and the incoming text stream. Text message material where no match is found is displayed in the normal way. Text messages can be stored in the transmitting mobile telephone 10 to be called up as a graphic to send a fixed message. A standard set of icons with fixed text in various languages can be called up by the sender and, on receipt, can be recognised and the text displayed in the language of choice of the receiver of the text message.

1. A method for receiving and viewing text messages, including the steps of: receiving a string of characters; successively comparing the characters in the string of characters with each of a stored array of groups of characters to seek any match therebetween, where each group of characters has, associated therewith, a respective image; successively displaying the string of characters; and, for any portion of the string of characters for which a match has been found, displaying the associated image together with that portion of the string of characters.

2. A method according to claim 1 wherein a said group of characters has, associated therewith, one or more alternative portions of the string of characters, a selectable one of said one or more alternative portions being displayable with said associated image.

3. A method according to claim 1 or claim 2 wherein the selected alternative portion is displayed instead of the portion of the string of characters for which a match was found.

4. A method according to any of claims 1 to 3 wherein the portion of the string of characters is displayed in a text box within the associated image.

5. Apparatus for receiving and viewing text messages, said apparatus comprising: means to receive a string of characters; means successively to compare the characters in the string of characters with each of a stored array of groups of characters to seek any match there-between, where each group of characters has, associated therewith, a respective image; means successively to display the string of characters; and means to display, for any portion of the string of characters for which a match has been found, the associated image together with that portion of the string of characters.

6. Apparatus according to claim 5 wherein a said group of characters has, associated therewith, one or more alternative portions of the string of characters, a selectable one of said one or more alternative portions being displayable with said associated image.

7. Apparatus according to claim 5 or claim 6 wherein the selected alternative portion is displayed instead of the portion of the string of characters for which a match was found.

8. Apparatus according to any of claims 5 to 7 wherein the portion of the string of characters is displayed in a text box within the associated image.

9. A method for generating text messages, including the steps of: selecting, from among a library of text images, a sequence of text images to form a message, each text image having associated therewith a sequence of characters; concatenating the sequence of characters to form a text message; and sending the text message to a selected recipient.

10. A method according to claim 9 wherein at least some of the text images are representations, pictograms or ideograms of the content of associated sequence of characters.

11. A method according to claim 9 or claim 10 wherein a sequence of characters is independently entered, a textless image is selected from among a plurality of textless images, and the independently entered sequence of characters is associated with the selected textless image and stored in said library as a text image.

12. A method according to any of claims 9 to 11 wherein the recipient of a text message is selected by selecting an image, representative of the desired recipient, from among a plurality of images of prospective recipients.

13. A method according to any of claims 9 to 12 wherein an independently entered recipient identification is associated with a selectable one from among a plurality of images, each potentially representative of a recipient, and stored among said plurality of images of prospective recipients.

14. A method according to any of claims 9 to 13 wherein an image of any kind is a caricature, a cartoon, a drawing or a photograph, and that the image is obtained from a server, a photographic source, by composition of elements from a store of elements, or from a pre-decided store.

15. Apparatus for generating text messages, said apparatus comprising: means for selecting, from among a library of text images, a sequence of text images to form a message, each text image having associated therewith a sequence of characters; means to concatenate the sequence of characters to form a text message; and means to send the text message to a selected recipient.

16. Apparatus according to claim 15 wherein at least some of the text images are representations, pictograms or ideograms of the content of associated sequence of characters.

17. Apparatus according to claim 15 or claim 16 wherein a sequence of characters can independently be entered, a textless image can be selected from among a plurality of textless images, and the independently entered sequence of characters can be associated with the selected textless image and stored in said library as a text image.

18. Apparatus according to any of claims 15 to 17 wherein the recipient of a text message can be selected by selecting an image, representative of the desired recipient, from among a plurality of images of prospective recipients.

19. Apparatus according to any of claims 15 to 18 wherein an independently entered recipient identification can be associated with a selectable one from among a plurality of images, each potentially representative of a recipient, and stored among said plurality of images of prospective recipients.

20. Apparatus according to any of claims 15 to 19 wherein an image of any kind is a caricature, a cartoon, a drawing or a photograph, and the image is obtained from a server, a photographic source, by composition of elements from a store of elements, or from a pre-decided store.

21. Apparatus according to any of claims 5 to 8 and 15 to 20, wherein the apparatus is a mobile telephone, a personal digital assistant or a computer.
